(19) United States
(12) Patent Application Publication
(10) Pub. No.: US 2016/0160737 A1
(43) Pub. Date: Jun. 9, 2016

(54) ENGINE SYSTEM HAVING COOLANT CONTROL VALVE

(71) Applicant: Hyundai Motor Company, Seoul (KR)

(72) Inventor: Hyo Jo LEE, Suwon-si (KR)

(73) Assignee: Hyundai Motor Company, Seoul (KR)

(21) Appl. No.: 14/729,438

(22) Filed: Jun. 3, 2015

(30) Foreign Application Priority Data
Dec. 3, 2014 (KR) 10-2014-0172136

(51) Int. Cl. F01P 7/14; F02M 26/23; F01P 11/08; F01P 5/10; F01P 3/02

(52) U.S. Cl. CPC F01P 7/14; F01P 5/10; F01P 3/02; F01P 11/08; F02M 26/23; F01P 2007/146; F01P 2003/027

(57) ABSTRACT

An engine system having a coolant control valve may include a cylindrical valve having a pipe structure with one side opened and including coolant passages formed in preset positions from one inner circumferential surface to an outer circumferential surface of the cylindrical valve to allow a coolant to pass therethrough, a valve housing configured for the cylindrical valve to be rotatably disposed therein and having connection pipes connected thereto to correspond to the coolant passages, a valve driving device, a pump housing disposed in one end portion of the cylindrical valve to correspond to the opened side of the cylindrical valve, having a pump impeller disposed therein, and coupled to the valve housing, a pump driving device disposed to rotate the pump impeller, and a pump discharge line connected to the pump housing to transmit a coolant pumped by the pump impeller to a cylinder block.

### CROSS-REFERENCE TO RELATED APPLICATION

The present application claims priority to Korean Patent Application No. 10-2014-0172136 filed Dec. 3, 2014, the entire contents of which is incorporated herein for all purposes by this reference.

### BACKGROUND OF THE INVENTION

1. Field of the Invention

The present invention relates to an engine system having a coolant control valve capable of simplifying an overall layout of a cooling system and enhancing control stability of a coolant by disposing the coolant control valve on an entrance side of a coolant of an engine and coupling the coolant control valve and a coolant pump.

2. Description of Related Art

An engine generates rotary power based on combustion of fuel and discharges the remaining energy as thermal energy. In particular, a coolant, while circulating in an engine, a heater, and a radiator, absorbs and discharges the thermal energy.

When a temperature of the coolant of the engine is low, viscosity of oil may increase to increase frictional force and fuel consumption, and a temperature of an exhaust gas may increase gradually to lengthen a time for a catalyst to be activated which degrades quality of the exhaust gas. In addition, a time required for a function of the heater to be normalized is increased to make a passenger or a driver feel cold.

If the temperature of the coolant of the engine is too high, knocking is generated, and adjustment of ignition timing to suppress generation of knocking may degrade performance. Also, if the temperature of the lubricant is too high, a lubricating operation may be degraded.

Thus, a single coolant control valve is applied to control several cooling elements such that the temperature of the coolant in a particular portion is maintained to be high and the temperature of the coolant in another portion is maintained to be low.

Among the several cooling elements, a cylinder block and a cylinder head are important, and a technique of separately cooling the cylinder block and the cylinder head has been researched.

Even though a single coolant control valve is used, an exit control scheme of controlling coolant discharged from the engine (cylinder block and cylinder head) and an entrance control scheme of controlling a coolant supplied to the engine are still generally used.

The exit control scheme may be vulnerable to rapid fluctuations of coolant temperature, precision of temperature controlling is lowered, and durability of the coolant control valve may be degraded.

In addition, the coolant pump is installed on the coolant entrance side of the engine together with the coolant control valve, and the coolant pump is installed on the coolant entrance side of the engine, resulting in a complicated layout of the cooling system overall.

The above information disclosed in this Background section is only for enhancement of understanding of the background of the invention and therefore it may contain information that does not form the prior art that is already known in this country to a person of ordinary skill in the art.

### BRIEF SUMMARY

Various aspects of the present invention are directed to providing an engine system having a coolant control valve having advantages of appropriately coping with rapid fluctuation in a coolant temperature, enhancing precision of temperature control, and simplifying a layout of a cooling system through a coupling structure of a valve housing and a pump housing.

According to various aspects of the present invention, an engine system having a coolant control valve may include a cylindrical valve having a pipe structure with one side opened and including coolant passages formed in preset positions from one inner circumferential surface to an outer circumferential surface of the cylindrical valve to allow a coolant to pass therethrough, a valve housing configured for the cylindrical valve to be rotatably disposed therein and having connection pipes connected thereto to correspond to the coolant passages, a valve driving device disposed in one end portion of the valve housing to rotate the cylindrical valve to connect the connection pipes and the coolant passages, a pump housing disposed in one end portion of the cylindrical valve to correspond to the opened side of the cylindrical valve, having a pump impeller disposed therein, and coupled to the valve housing, a pump driving device disposed to rotate the pump impeller, and a pump discharge line connected to the pump housing to transmit a coolant pumped by the pump impeller to a cylinder block.

The coolant pumped by the pump impeller may be supplied to the cylinder block through the pump discharge line, and a portion of the coolant supplied to the cylinder block may be supplied toward a cylinder head disposed above the cylinder block.

A remaining portion of the coolant, which has been supplied to the cylinder block, is supplied toward an oil cooler.

The coolant discharged from the cylinder head may be distributed to an exhaust gas recirculation (EGR) cooler, a heater core, or a radiator.

The connection pipes may include a first connection pipe configured to supply coolant discharged from the EGR cooler and the heater core to an inner side of the valve housing, a second connection pipe configured to supply coolant discharged from the radiator to the inner side of the valve housing, and a third connection pipe configured to supply coolant discharged from the oil cooler to the inner side of the valve housing.

The cylindrical valve and the pump impeller may be arranged to be adjacent in a horizontal direction.

The cylindrical valve and the pump impeller may be arranged to be adjacent in a vertical direction.

The pump housing and the valve housing may be integrally formed.

Sealing members may be interposed between an inner circumferential surface of the valve housing and an outer circumferential surface of the cylindrical valve such that the sealing members correspond to the connection pipes.

The EGR cooler and the heater core may be disposed in a single coolant line.

The cylindrical valve and the pump impeller may be disposed such that rotation central axes thereof are aligned or are perpendicular to each other.

According to various embodiments of the present invention, since the coolant control valve is installed in the coolant entrance side of the engine to enhance temperature control precision of a coolant and the coolant control valve and the coolant pump are coupled to be configured as a single module, a layout of the cooling system may be simplified.

In addition, since the coolant control valve separately cools the cylinder head and the cylinder block and separately controls the coolants circulating in the EGR cooler, the heater core, the oil cooler, and the radiator, overall stability of the cooling system and control efficiency may be enhanced.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating an overall flow of a coolant in an exemplary engine system having a coolant control valve according to the present invention.

FIG. 2 is a partial cross-sectional view of the exemplary engine system having the coolant control valve according to the present invention.

FIG. 3 is a partial cross-sectional view of an exemplary engine system having a coolant control valve according to the present invention.

FIG. 4 is a partial cross-sectional view of the coolant control valve related to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

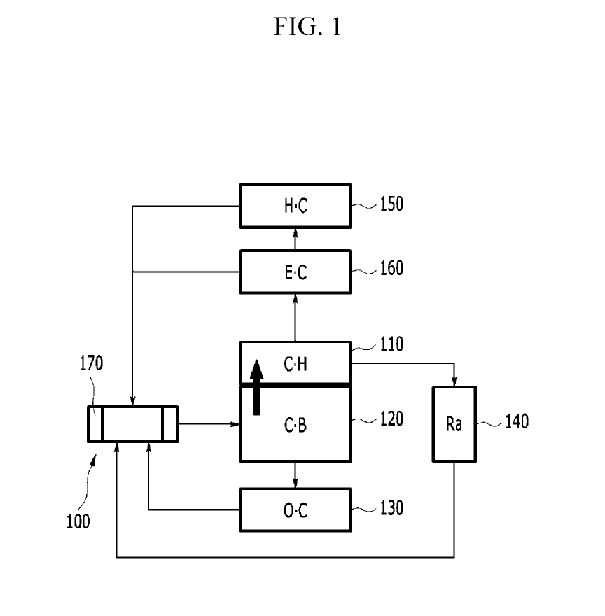

FIG. 1 is a flowchart illustrating an overall flow of a coolant in an engine system having a coolant control valve according to various embodiments of the present invention.

Referring to FIG. 1, an engine system includes a coolant control valve 100, a cylinder head 110, a cylinder block 120, an oil cooler 130, a radiator 140, a heater core 150, an exhaust gas recirculation (EGR) cooler 160, and a coolant pump 170.

The coolant pump 170 is integrally coupled with the coolant control valve 100, and pumps a coolant discharged to the coolant control valve 100 to supply the coolant to the cylinder block 120.

The coolant supplied to the cylinder block 120 is distributed to the cylinder head 110, the coolant flowing through the cylinder block is discharged to the oil cooler 130, and the coolant supplied to the cylinder head 110 is distributed to the EGR cooler 160, the heater core 150, and the radiator 140. The heater core 150 and the EGR cooler 160 are connected by a single coolant line.

In addition, the coolant discharged from the heater core 150 and the EGR cooler 160, the coolant discharged from the oil cooler 130, and the coolant discharged from the radiator 140 recirculate to the coolant control valve 100 to be pumped by the coolant pump 170 again.

Thus, when the coolant control valve 100 blocks the coolant discharged from the heater core 150 and the EGR cooler 160, the coolant does not circulate to the heater core 150 and the EGR cooler 160, when the coolant control valve 100 blocks the coolant discharged from the oil cooler 130, the coolant does not circulate to the oil cooler 130 and the cylinder block 120, and when the coolant control valve 100 blocks the coolant discharged from the radiator 140, the coolant does not circulate to the radiator 140.

In addition, when the coolant control valve 100 blocks the coolant discharged from the heater core 150, the EGR cooler 160, and the radiator 140, the coolant does not circulate to the cylinder head 110.

In various embodiments of the present invention, the heater core 150 serves to heat an interior space of a vehicle using a warm circulating coolant, the EGR cooler 160 serves to cool a recirculation exhaust gas recirculating from an exhaust line to an intake line, the radiator 140 serves to outwardly release heat of the coolant, and the oil cooler 130 serves to cool oil circulating through the cylinder head 110 or the cylinder block 120.

As described above, the coolant control valve 100 and the coolant pump 170 may be integrally coupled to reduce assembling cost and simplify the layout.

In addition, since an entrance control scheme instead of an exit control scheme is applied to the coolant, coolant stability of the engine may be enhanced, and since the coolants circulating in the cylinder block 120, the cylinder head 110, the EGR cooler 160, the heater core 150, and the radiator 140 are separately controlled by the single coolant control valve 100, an overall cooling system may be effectively controlled.

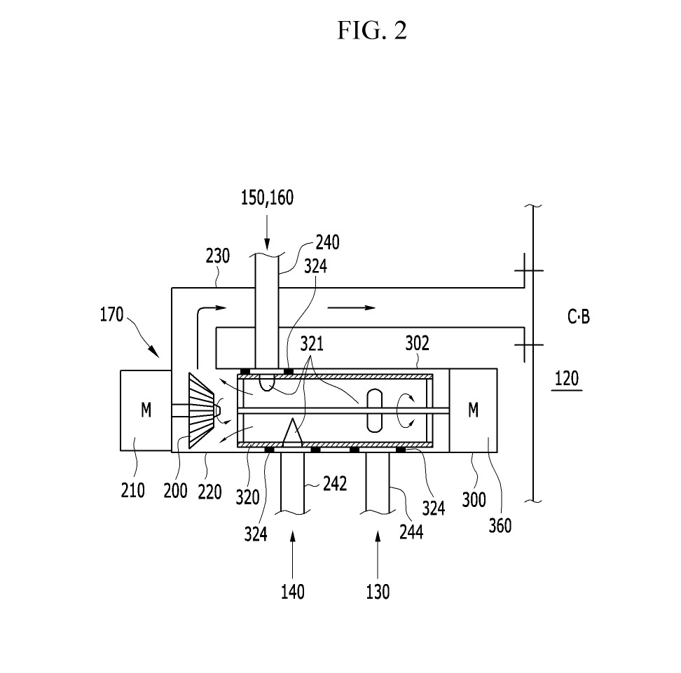

FIG. 2 is a partial cross-sectional view of the engine system having a coolant control valve according to various embodiments of the present invention.

Referring to FIG. 2, the coolant control valve 100 includes a cylindrical valve 320, a valve housing 302, a motor housing 300, a rotational shaft 315, a first connection pipe 240, a second connection pipe 242, and a third connection pipe 244, and the coolant pump 170 includes a pump housing 220, a pump impeller 200, a pump motor 210, and a pump discharge pipe 230.

The valve housing 302 and the pump housing 220 are integrally formed, the motor housing 300 in which a motor 360 is installed is disposed in one end portion of the valve housing 302, and the cylindrical valve 320 is installed within the valve housing 302.

The cylindrical valve 320 has a pipe structure in which the interior is hollow and one side thereof is open, and coolant passages 321 are formed in preset positions from an inner circumferential surface to an outer circumferential surface. As illustrated, three coolant passages 321 may be formed in preset positions.

The cylindrical valve 320 is connected to the motor 360 of the motor housing 300 through the rotational shaft 315, and is disposed to be rotatable about the rotational shaft 315 according to rotation of the motor 360.

The pump impeller 200 is disposed within the pump housing 220 at a preset interval from the other end of the cylindrical valve 320, and the pump motor 210 is disposed to rotate the pump impeller 200. When the pump impeller 200 rotates by the pump motor 210, the coolant present within the cylindrical valve 320 is sucked and pumped in a radial direction of the pump impeller 200.

The coolant pumped by the pump impeller 200 is directly supplied to the coolant chamber of the cylinder block 120 through the pump discharge pipe 230.

In various embodiments of the present invention, the first connection pipe 240, the second connection pipe 242, and the third connection pipe 244 are connected to the valve housing 302 to correspond to the coolant passages 321. The first connection pipe 240 receives the coolant from the heater core 150 and the EGR cooler 160, the second connection pipe receives the coolant from the radiator 140, and the third connection pipe 244 receives the coolant form the oil cooler 130.

In addition, sealing members 324 are interposed between an inner circumferential surface of the valve housing 302 and the cylindrical valve 320 such that the sealing members 324 correspond to the first, second, and third connection pipes 240, 242, and 244, enhancing control precision of the coolant.

As illustrated, the valve housing 302 and the pump impeller 200 are disposed in a horizontal direction, and one open portion of the valve housing 302 is disposed to be adjacent to the pump impeller 200, thereby minimizing intake resistance of the pump impeller 200.

Here, a rotation central axis of the pump impeller 200 and a rotation central axis of the cylindrical valve 320 are aligned. In addition, the rotation central axis of the pump impeller 200 and the rotation central axis of the cylindrical valve 320 may be disposed to be parallel, rather than being coaxial.

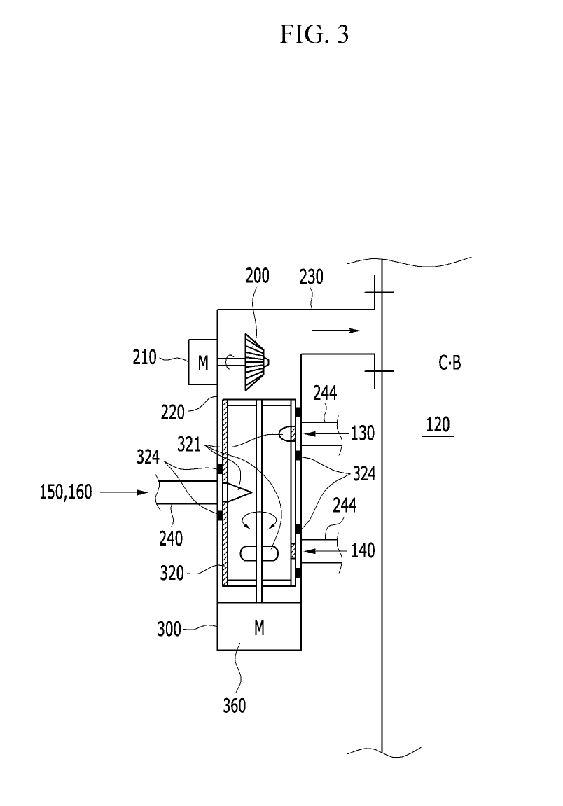

FIG. 3 is a partial cross-sectional view of the engine system having a coolant control valve according to various embodiments of the present invention. Differences from the various embodiments of FIG. 2 will be described.

Referring to FIG. 3, the motor housing 300, the cylindrical valve 320, the pump impeller 200, and the pump motor 210 are arranged vertically in an upward direction.

In various embodiments of the present invention, the pump motor 210, the pump impeller 200, the cylindrical valve 320, and the motor housing 300 may be arranged vertically in an upward direction.

As illustrated, since the valve housing 302 and the pump impeller 200 are disposed in a vertical direction and the upper open portion of the valve housing 302 is disposed to be adjacent to the pump impeller 200, intake resistance of the pump impeller 200 may be minimized.

Here, the rotation central axis of the pump impeller 200 and the rotation central axis of the cylindrical valve 320 are disposed to be perpendicular to each other. In addition, the pump impeller 200 and the cylindrical valve 320 may be disposed such that a rotation central axis of the pump impeller 200 and a rotation central axis of the cylindrical valve 320 are aligned.

As described above, since the cylindrical valve 320 and the pump impeller 200 are arranged in the vertical direction, the overall coolant pump 170 and the coolant control valve 100 are disposed vertically or horizontally in a length direction, whereby a layout coupled to the engine may be variously modified.

FIG. 5 is a partial cross-sectional view of the coolant control valve related to the present invention. The coolant control valve illustrated in FIG. 5 is for better understanding of the present invention, and the structure of the coolant control valve according to the present invention differs from that of previously described embodiments in some parts.

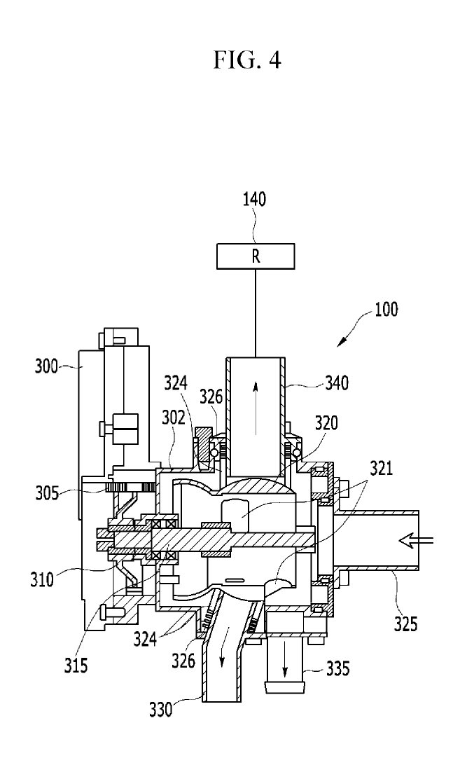

Referring to FIG. 4, the coolant control valve 100 includes the motor housing 300 in which the motor 360 is installed, an output gear 305 rotated by the motor, and a driven gear 310 rotated by the output gear 305. The driven gear 310 is disposed to rotate the cylindrical valve 320.

The cylindrical valve 320 has a pipe structure in which both ends thereof are open and a space is formed in a central portion in a length direction thereof. Coolant passages 321 leading from a space of the central portion to an outer surface are formed in the cylindrical valve 320.

In the valve housing 302 in which the cylindrical valve 320 is installed, a first entrance pipe 325 is disposed in one end portion and the motor housing 300 is connected to the other end portion.

In the valve housing 302, a radiator supply pipe 340 connected to the radiator 140, a second entrance pipe 330 connected to the cylinder head, and a heater supply pipe 335 connected to the heater are disposed.

The sealing members 324 are disposed on an outer circumferential surface of the cylindrical valve 320, a front end portion of the radiator supply pipe 340 is inserted to an inner side of the sealing members 324, and an elastic member 326 elastically pushes the sealing members 324 toward an outer circumferential surface of the cylindrical valve 320, thus forming a sealing structure.

A control unit controls the motor within the motor housing 300 according to operation conditions, namely, a coolant temperature, an intake temperature, and the like, to rotate the cylindrical valve 320 with respect to the rotational shaft 315 disposed along the central axis of the cylindrical valve 320 in the length direction through the output gear 305 and the driven gear 310.

Also, when the passages 321 of the cylindrical valve 320 correspond to the first entrance pipe 325 or the second entrance pipe 330, the coolant flows.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine system having a coolant control valve, the engine system comprising:
a cylindrical valve having a pipe structure with one side of the cylindrical valve opened and including coolant passages formed in predetermined positions from an inner circumferential surface to an outer circumferential surface of the cylindrical valve to allow a coolant to pass therethrough;
a valve housing, wherein the cylindrical valve is rotatably disposed in the valve housing and the valve housing includes connection pipes connected to the valve housing to correspond to the coolant passages;
a valve driving device disposed in an end portion of the valve housing and connected to the cylindrical valve to rotate the cylindrical valve to selectively fluid-connect the connection pipes and the coolant passages;
a pump housing disposed in an end portion of the cylindrical valve to correspond to the opened side of the cylindrical valve, having a pump impeller disposed therein, and coupled to the valve housing;
a pump driving device connected to the pump impeller and disposed to rotate the pump impeller; and
a pump discharge line connected to the pump housing to transmit a coolant pumped by the pump impeller to a cylinder block.

2. The engine system of claim 1, wherein the coolant pumped by the pump impeller is supplied to the cylinder block through the pump discharge line, and a portion of the coolant supplied to the cylinder block is supplied toward a cylinder head disposed above the cylinder block.

3. The engine system of claim 2, wherein a remaining portion of the coolant, which has been supplied to the cylinder block, is supplied toward an oil cooler.

4. The engine system of claim 3, wherein the coolant discharged from the cylinder head is distributed to an exhaust gas recirculation (EGR) cooler, a heater core, or a radiator.

5. The engine system of claim 4, wherein the connection pipes comprise:
a first connection pipe configured to supply coolant discharged from the EGR cooler and the heater core to an inner side of the valve housing;
a second connection pipe configured to supply coolant discharged from the radiator to the inner side of the valve housing; and
a third connection pipe configured to supply coolant discharged from the oil cooler to the inner side of the valve housing.

6. The engine system of claim 1, wherein the cylindrical valve and a rotation axis of the pump impeller are arranged to be adjacent in a horizontal direction from each other.

7. The engine system of claim 1, wherein the cylindrical valve and a rotation axis of the pump impeller are arranged to be adjacent in a vertical direction from each other.

8. The engine system of claim 1, wherein the pump housing and the valve housing are integrally formed.

9. The engine system of claim 1, wherein sealing members are interposed between an inner circumferential surface of the valve housing and the outer circumferential surface of the cylindrical valve such that the sealing members correspond to the connection pipes.

10. The engine system of claim 1, wherein the EGR cooler and the heater core are disposed in a single coolant line.

11. The engine system of claim 1, wherein the cylindrical valve and the pump impeller are disposed such that rotation central axes thereof are coaxially aligned or are perpendicular to each other.
